(19) United States
(12) Patent Application Publication
(10) Pub. No.: US 2012/0280484 A1
(43) Pub. Date: Nov. 8, 2012

(54) FILM BEARING CONTINOUSLY PRINTED LABELS TO BE SUBJECTED TO HEAT-SHRINKING

(75) Inventor: Mario Ballarotti, Marmirolo (IT)

(73) Assignee: P.E. LABELLERS S.p.A., Porto Mantovano (IT)

(21) Appl. No.: 13/520,797

(22) PCT Filed: Dec. 20, 2010
(86) PCT No.: PCT/EP2010/070307

§ 371 Date: Jul. 6, 2012

(30) Foreign Application Priority Data
Jan. 8, 2010 (IT) MI2010A000009

(51) Int. Cl. B42D 15/00

(52) U.S. Cl. 283/81

(57) ABSTRACT

A film bearing continuously printed labels to be subjected to heat-shrinking and designed to be processed by a labelling machine which comprises a rotating carousel for supporting the individual containers to be labelled and which is provided with elements that convey the film, drawing it from a reel, to be cut so as to separate the individual labels and bring each one into contact with a dummy bottle, so that each one of the labels completely surrounds one of the dummy bottles, forming a sleeve, transfer elements being also provided which are adapted to transfer the sleeve, which is now closed, to the underlying container, the film being a flat film which is pretreated with adhesive at a strip at an end flap of each individual label that corresponds to an overlap region so as to form the closed sleeve in contact with the corresponding dummy bottle.

The present invention relates to a film bearing continuously printed labels to be subjected to heat-shrinking.

### BACKGROUND OF THE INVENTION

It is known that the operation of labelling containers that have a surface provided with a particular shape involves the formation of a sleeve that bears the printed label and which is brought to surround a container in order to be subjected to a heat-shrinking action that brings it to achieve a condition of perfect adherence with the container.

The known art involves the use of a tubular film which bit by bit is cut to size, so producing sleeves that are applied in sequence to the containers to be labelled, but this method of working suffers the drawback of high cost and lengthy executive times, particularly for containers with a pronounced axial development.

To solve these problems, labelling machines are currently adopted that have a rotating carousel for supporting the individual containers to be labelled, and are provided with means that convey a flat film that bears the continuously printed labels, drawing it from a reel, to be cut so as to separate the individual labels and bring them into contact with a cylindrical element, known as a “dummy bottle”, which lies above the position of each container that is present on the rotating carousel.

In this way the labels are brought to completely surround, with a slight overlap at the end flaps, the dummy bottles, and are ready to be transformed into sleeves: it is sufficient to perform the closing, with mutual fixing, of the overlapped end flaps in order to obtain the sleeves, which adapted means then transfer to the underlying individual containers which, in this way, are prepared for the heat-shrinking operation.

The flat film that is processed by the known labelling machines is without glue of the type that is spread on the production line, by means of known gluing assemblies, onto the film, because this glue would not be capable of resisting the subsequent heat-shrinking operation, and therefore in order to achieve the closing operation of the individual sleeves the application of laser or ultrasound is resorted to. There are, however, some disadvantageous characteristics such as the frequent decalibrations determined by the although minimal variations in composition intrinsic in the plastic material of the film, and moreover the tab that is inevitably present at the end of each sleeve created by means of laser or ultrasound tends to take on an unpleasant appearance following the heat-shrinking operation.

### SUMMARY OF THE INVENTION

The aim of the present invention is to provide a film bearing continuously printed labels that optimally achieves the formation, on the dummy bottles, of the sleeves to be transferred to the containers to be labelled.

This aim is achieved by a film bearing continuously printed labels to be subjected to heat-shrinking, according to the invention, characterised in that it comprises the features disclosed in the appended claim.

### BRIEF DESCRIPTION OF THE DRAWINGS

Further characteristics and advantages of the invention will become better apparent from the description of a preferred, but not exclusive, embodiment thereof, illustrated by way of non-limiting example in the accompanying drawings wherein:

FIG. 1 shows a detailed partial perspective view of the machine designed to process the film according to the invention;

FIG. 2 is similar to FIG. 1 from a different point of view;

FIG. 3 shows the detail highlighted in FIG. 2, enlarged.

### DESCRIPTION OF THE PREFERRED EMBODIMENTS

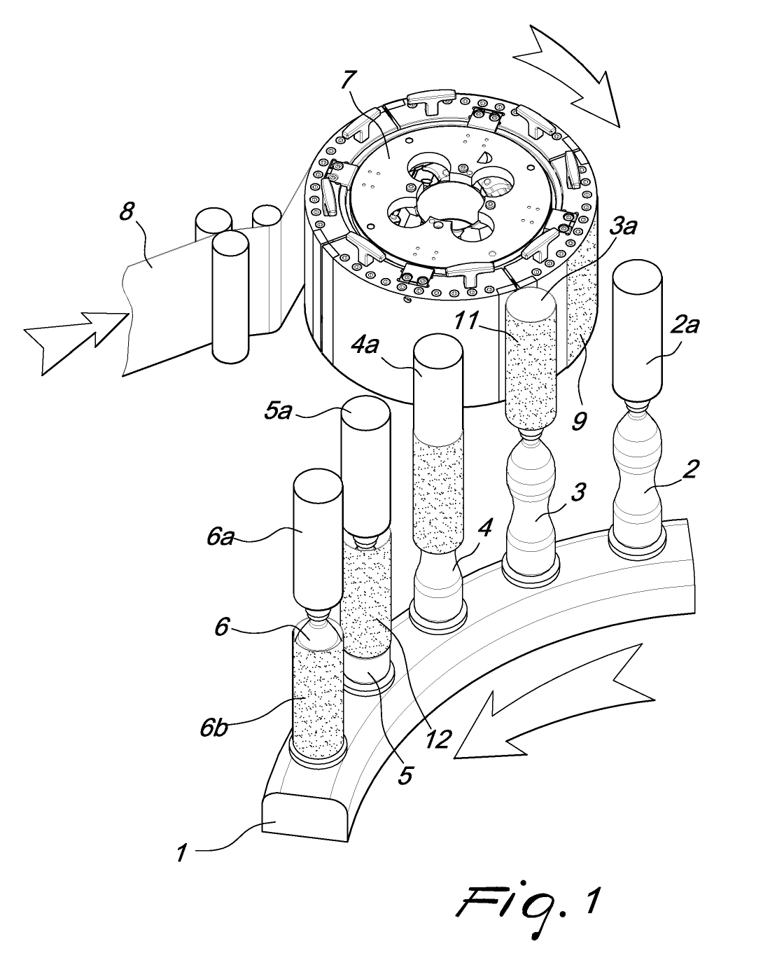

With reference to the figures, the reference numeral 1 indicates the carousel comprised in a labelling machine that is designed to process the film according to the invention, rotating in the direction of the arrow that can be seen in the figures and provided with load plates which are adapted to each support a container to be labelled such as those indicated in FIGS. 1 and 2 with 2, 3, 4, 5, 6.

The containers 2 present a surface that has a particular shape, and therefore it clearly appears that the process of heat-shrinking the applied labels is made necessary in order that the labels associate with the corresponding containers in conditions of perfect adherence.

Above each load plate of the carousel there is a cylindrical element known as a “dummy bottle” covered in an anti-adhesive material, which can be constituted for example by the end portion of the jack that performs the task of pushing a container onto the corresponding supporting load plate so as to lock it in place, and the dummy bottles corresponding to the containers 2, 3, 4, 5, 6 are indicated respectively with 2a, 3a, 4a, 5a, 6a.

The labelling machine also comprises a cutting and transfer drum 7 that receives a flat film 8 upon which the labels are continuously printed, and performs the cutting of the film so as to separate individual labels such as those indicated respectively with 9 and 10, and brings each of these labels into contact with a dummy bottle.

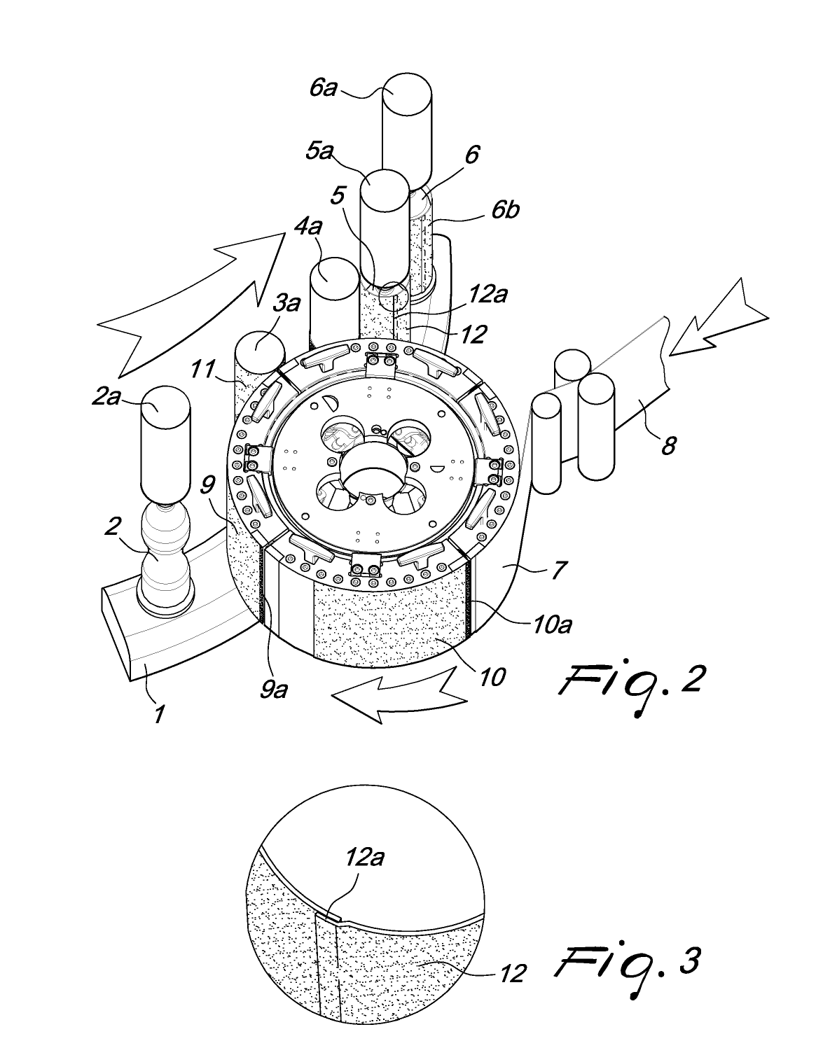

In this way each label completely surrounds the dummy bottle upon which it has been placed, as shown for label 11 on the dummy bottle 3a, with a slight overlap at the end flaps like that which can be clearly seen, indicated with 12a in FIGS. 2 and 3, for label 12 which is currently being transferred, as will be better described hereinbelow, from the dummy bottle 5a around which it was wrapped to the underlying container 5.

According to the invention each label is provided, at an end flap at the overlap area, with a strip that is pretreated with adhesive 9a and 10a respectively for the labels 9 and 10, and the mere contact of the end flaps of a label in the overlap area determines the closure by gluing of the sleeve thus formed.

The machine is completed by known means, not shown in the figures, which transfer the closed sleeves from the condition of surrounding the corresponding dummy bottles to the underlying containers, and the figures show a sequence of containers supported by the rotating carousel, each of which is in one of the conditions that follow on from each other during the operation.

Therefore, the container 2 is waiting for the dummy bottle 2a above to receive a label from the drum 7 for the formation of the corresponding sleeve, the container 3 is ready to receive the label 11 which by now has been moulded into a closed sleeve, the containers 4 and 5 are receiving the corresponding sleeves which are descending from the corresponding dummy bottles in the direction of the arrows in FIG. 1, and finally the container 6 is by now completely surrounded by the corresponding sleeve 6b, and is therefore ready to be subjected to the heat-shrinking operation which will not be capable of causing any degradation in the strips which are pretreated with adhesive and which ensure the closure of the sleeves.

The invention as described is susceptible of numerous modifications and variations, all of which are within the scope of the appended claims. Moreover, all the details may be replaced with other technically equivalent elements.

The disclosures in Italian Patent Application No. MI2010A000009 from which this application claims priority are incorporated herein by reference.

1. (canceled)

2. A film bearing continuously printed labels to be subjected to heat-shrinking and designed to be processed by a labelling machine which comprises a rotating carousel for supporting the individual containers to be labelled and which is provided with means that convey the film, drawing it from a reel, to be cut so as to separate individual labels and bring each one into contact with a dummy bottle which lies above the position of each container that is present on said rotating carousel, so that each one of said labels completely surrounds, with a slight overlap at the end flaps, one of said dummy bottles, forming a sleeve, transfer means being provided which are adapted to transfer said sleeve, which is now closed, to the underlying container, wherein said film is a flat film which is pretreated with adhesive at a strip at an end flap of each individual label that corresponds to the overlap region so as to form the closed sleeve in contact with the corresponding dummy bottle.
